(19) United States
(12) Patent Application Publication
(10) Pub. No.: US 2011/0031738 A1
(43) Pub. Date: Feb. 10, 2011

(54) Pipe Coupling Spacer Insert

(75) Inventor: David Vernon Person, Missouri City, TX (US)

Correspondence Address: National Oilwell Varco, c/o Williams, Morgan & Amerson, 10333 Richmond, Suite 1100, Houston, TX, 77042, US

(73) Assignee: National Oilwell Varco, L.P.

(21) Appl. No.: 12/906,299

(22) Filed: Oct. 18, 2010

Related U.S. Application Data
(62) Division of application No. 11/825,317, filed on Jul. 5, 2007.

(51) Int. Cl. F16L 21/00; F16L 35/00

(52) U.S. Cl. 285/31; 285/36

(57) ABSTRACT

A tubular coupling system and a protective spacer for use within a coupling, and methods of their use. The spacer, in at least one embodiment, has two or more separate and separable members that are length-adjustable to accommodate different distances between ends of two tubulars connected with a coupling.

### CROSS REFERENCE TO RELATED APPLICATIONS

This application is a divisional application depending from U.S. patent application Ser. No. 11/825,317 filed on Jul. 5, 2007, which is hereby incorporated by reference herein for all it discloses. No new matter has been added.

### BACKGROUND OF THE INVENTION

1. Field of the Invention

The present invention is directed to tubular coupling structures; spacers for an area between two spaced-apart tubular ends within a coupling; and, in one particular aspect, to combinations of a pipe coupling, a protective interior spacer, and two pieces of pipe coupled together by the coupling.

2. Description of the Related Art

Many tubulars are used to transmit corrosive or erosive materials. Many piping systems and pipelines transport fluids that are highly corrosive to the carbon steel used in the pipe. To overcome corrosion problems, and as well known to those skilled in the art, it is common to use lined or coated steel pipe, with liners or coatings made of plastic, stainless steel, or other corrosion-resistant materials.

Often it is necessary to couple threaded tubulars in a manner to protect the coupled tube ends from corrosion. In some applications of this type, the interior surface of the tubulars is coated, including nose portions, and the coupling with a coating, e.g. plastic, to protect the interior surfaces of the metal tubulars and coupling from corrosion. During coupling or make-up of the tubing in the field, the corrosion-resistant plastic coating is subject to mechanical damage and removal of portions of the coating, particularly at or near the tubing ends. This coating damage, and additionally the turbulent flow pattern that occurs in this area of the tubular product during use, can result in both abrasion and erosion of the exposed metal along with subsequent corrosion as exposed metal contacts the corrosive fluid product in the tubulars against which the plastic coating was originally intended to protect.

In many instances tubulars are uncoupled and reused in subsequent make-up tubular products of this type. Each time a tubular is subjected to additional make-up, the threaded portion of the ends can be distorted so that the ends extend a greater distance within the coupling during each additional make-up. This dimensional change may require the use of a protector, or gasket insert of different dimensions than used during the initial make-up. This adds to the cost and complexity of the make-up operation. In addition, if the dimensions of the insert are not correct, effective compression will not be achieved. Also, this may result in the ends damaging the insert during make-up. Specifically, if the insert dimension is too short, which limits effective contact with both ends, proper protection of the ends will not be achieved. If the insert is too long, it will be distorted during make-up to limit the protection it can afford, reducing the inside diameter at the coupling, and increasing the turbulence of flow through the coupling.

Certain typical multiple-walled pipe, e.g., a lined steel pipe, is a dual or double-walled pipe in which the inner wall is a liner tube made of a corrosion-resistant material that serves as a conductor for the corrosive fluid, and an outer wall or pipe that is designed to provide strength to withstand the internal pressures of the corrosive fluid, as well as external forces such as mechanical loading, etc. In certain tubulars, there are limitations on the length of such double-walled pipes due to conditions to which the pipes are subjected on site. Thus, in the case of tubing or casing strings and in the production of oil and gas, each joint of pipe is usually between about twenty-four to forty-four feet long while the tubing or casing string itself may be thousands of feet long.

Accordingly, and as is well known in making up a variety of such tubing or casing strings, often successive joints of tubing/casing are connected together using couplings until the desired length of string is achieved. Similarly in pipelines successive pieces of pipe are joined by couplings.

It is desirable, where successive joints of the lined, coated, or clad pipe are joined to one another by means of a coupling that the interior of the coupling is protected from corrosion. Many prior art coupling and seal systems attempt an effective coupling structure, e.g., and not by way of limitation, as disclosed in the subject matter of U.S. Pat. Nos. 590,811; 1,909,075; 2,040,786; 2,233,734; 2,805,872; 4,679,831; 4,856,828; 5,282,652; 5,470,111; 5,689,871; 6,312,024; 6,863,313; and U.S. application Ser. No. 10/513,213 filed May 5, 2003, all of which patents and applications are incorporated fully herein for all purposes.

### BRIEF SUMMARY OF THE INVENTION

The present invention discloses, in certain embodiments, a coupled pipe system including two spaced-apart tubulars, each with an end threadedly engaged in an end of a coupling, with the ends of the tubulars spaced apart within the coupling and a length-adjustable spacer located within the coupling between the two tubulars ends. The adjustable spacer allows for varying degrees of make-up between the adjacent tubular sections and the spacer protects coatings on the ends of the tubulars. The spacer also protects the interior surface of the coupling adjacent the spacer and provides a smooth transition across the coupling to reduce the effects of fluid turbulence on the coupling and on the tubulars.

The present invention discloses, in certain embodiments and aspects, a spacer for use within a coupling to abut ends of spaced-apart tubulars connected by the coupling. The spacer is length-adjustable, as viewed from the side, so that it can accommodate a range of distances between ends of adjacent tubulars connected by the coupling. The spacer can thus accommodate new tubulars connected by the coupling as well as used tubulars that may have been distorted during use and which end up spaced-apart a different distance within the coupling when they are used again following distortion. Used, distorted tubulars often end up threaded further into a coupling than when they were new and, therefore closer together within a coupling as compared to the distance they were apart when new.

The present invention discloses, in certain embodiments, a length-adjustable spacer that protects part of the interior surface of a coupling as well as coated ends of tubulars connected by the coupling. Such a spacer, in certain aspects, provides a smooth surface that is exposed to fluid flowing through the tubulars and through the coupling so that fluid turbulence has less of a deleterious effect at the coupling and, therefore, on the tubular string.

The present invention discloses methods for coupling together two tubulars with a coupling using a spacer according to the present invention.

The present invention, in certain embodiments, discloses a coupling systems for connecting two tubulars, the coupling system having: a coupling; a first tubular and a second tubular connected together by the coupling, each tubular having a tubular end within the coupling, the tubular ends spaced-apart from each other; a spacer between the tubular ends and in contact therewith, the spacer having two parts or at least two parts, the part(s) movable with respect to each other.

The present invention discloses, in some embodiments, a spacer for use in a coupling for coupling together two tubulars, the coupling with a coupling body, the coupling body being generally cylindrical and having a channel therethrough, the coupling body with two spaced-apart ends, each end threaded for threaded mating with a tubular so that the coupling connects the two tubulars, the coupling having an interior wall, the spacer having: two parts (or three, four, or more parts), at least a first part and a second part, the first part movable with respect to the second part to accommodate a distance within a coupling between spaced-apart ends of two tubulars connected by the coupling.

Disclosed herein are systems and methods that employ an inner protective spacer in a space between the coupled ends of two spaced-apart tubulars, the spacer being adjustable to accommodate different distances between the ends of the tubulars, whether the distance is due to varying degrees of coupling make-up or due to distortion of the tubular ends, or both.

Systems and spacers in which the spacer protects part of the interior surface of a coupling and coated ends of tubulars connected by the coupling are also disclosed.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

It will be understood that the various embodiments of the present invention may include one, some, or all of the disclosed, described, and/or enumerated improvements and/or technical advantages and/or elements in claims to this invention.

### BRIEF DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1 is a side view of a coupling system according to the present invention.

FIG. 1A is an exploded side cross-section view of the coupling system of FIG. 1.

FIG. 1B is a side cross-section of a system according to the present invention.

FIG. 1C is a side cross-section of a system according to the present invention.

FIG. 1D is a side cross-section of a system according to the present invention.

FIG. 2A is a side cross-section view of a male part of a coupling system according to the present invention.

FIG. 2B is a side cross-section view of a female part of the coupling system which includes the part shown in FIG. 2A.

FIG. 3A is a side cross-section view of a male part of a coupling system according to the present invention.

FIG. 3B is a side cross-section view of a female part of the coupling system which includes the male part shown in FIG. 3A.

FIG. 4 is a side view, partially in cross-section, of a female part of a coupling system according to the present invention.

FIG. 4A is another side view, partially in cross-section, of the female part of FIG. 4.

FIG. 4B is a bottom view of the female part of FIG. 4.

FIG. 5 is a side view of a male part used with the female part of FIG. 4.

FIG. 5A is a side cross-section view of the male part of FIG. 5.

FIG. 5B is a bottom view of the male part of FIG. 5.

FIG. 6 is a side view of a spacer according to the present invention.

FIG. 6A is a side view of a spacer according to the present invention.

FIG. 7 is a side cross-section view of a coupling system according to the present invention.

FIG. 8A is a side view of a male part of a spacer according to the present invention.

FIG. 8B is a side view of a female part of a spacer according to the present invention.

Presently preferred embodiments of the invention are shown in the above-identified figures and described in detail below. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) herein, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

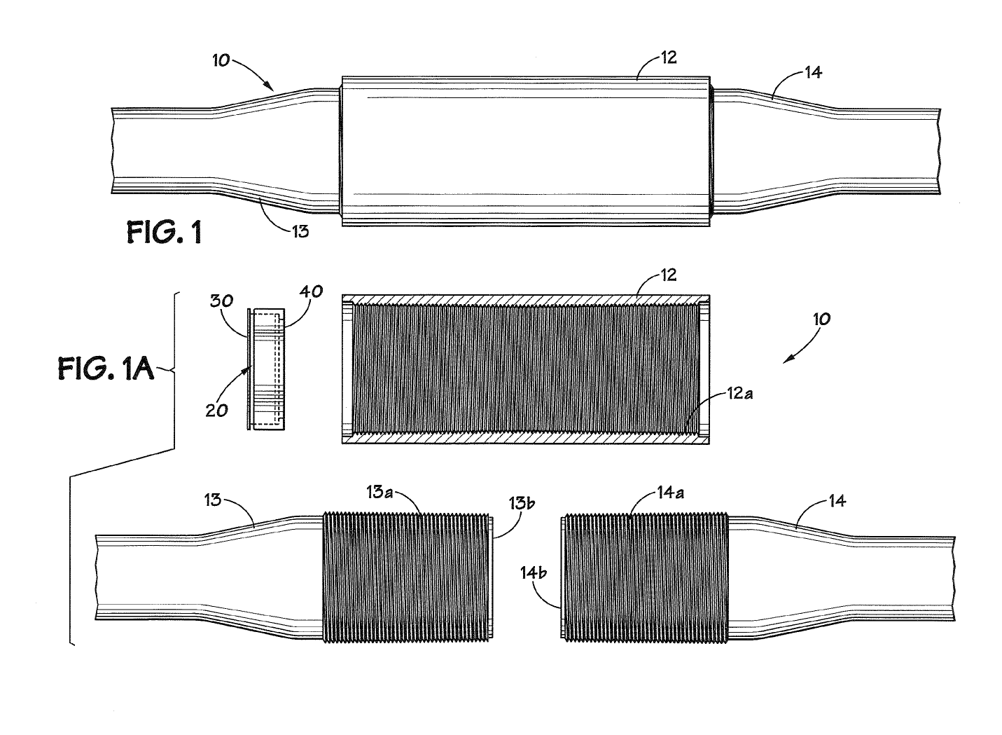

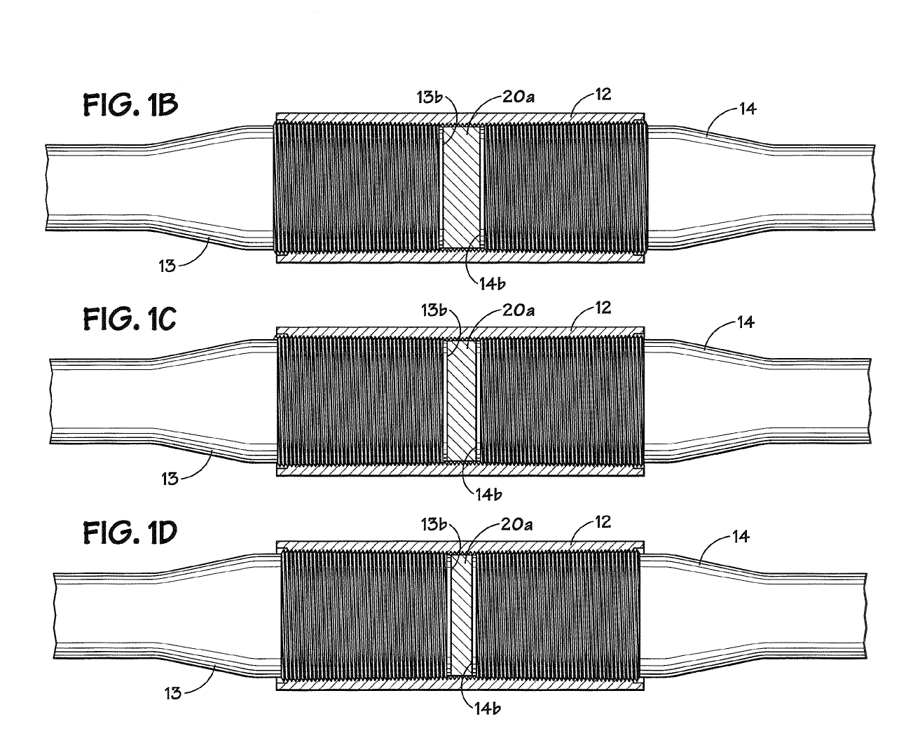

As shown in FIGS. 1 and 1A, a coupling system 10 according to the present invention a coupling 12 with internal threading 12a; two tubulars 13, 14 each with a threaded end 13a, 14a, respectively; and a spacer 20 according to the present invention. With the two tubulars 13, 14 connected together within the coupling 12, end surfaces 13b, 14b of the tubulars, respectively, are spaced apart and there is a void space between them. The spacer 20 occupies this void space.

The threaded end 13a is threaded into the coupling 12. The spacer 20 is then installed in the coupling 12 so that part of the spacer 20 contacts the end surface 13b of the threaded end 13a. Then the tubulars 13, 14 are threaded into and tightened within the coupling 12. As shown in FIG. 1B in certain aspects the end surfaces 13b, 14b contact a spacer 20a (shown schematically; like the spacer 20, but may be any spacer according to the present invention) as the tubulars 13, 14 are being tightened to the coupling 12. As shown in FIG. 1C as the tubulars 13, 14 are tightened further, the spacer compresses to accommodate this further tightening, with surfaces of the spacer 20 remaining in contact with both end surfaces 13a, 13b. As shown in FIG. 1D with the tubulars 13, 14 in place and with no further tightening to be done, the spacer 20 contacts and protects each end surface 13a, 13b; fills the void area between the ends of the tubulars 13, 14; and provides a relatively smooth inner surface across which fluid may flow, reducing fluid turbulence.

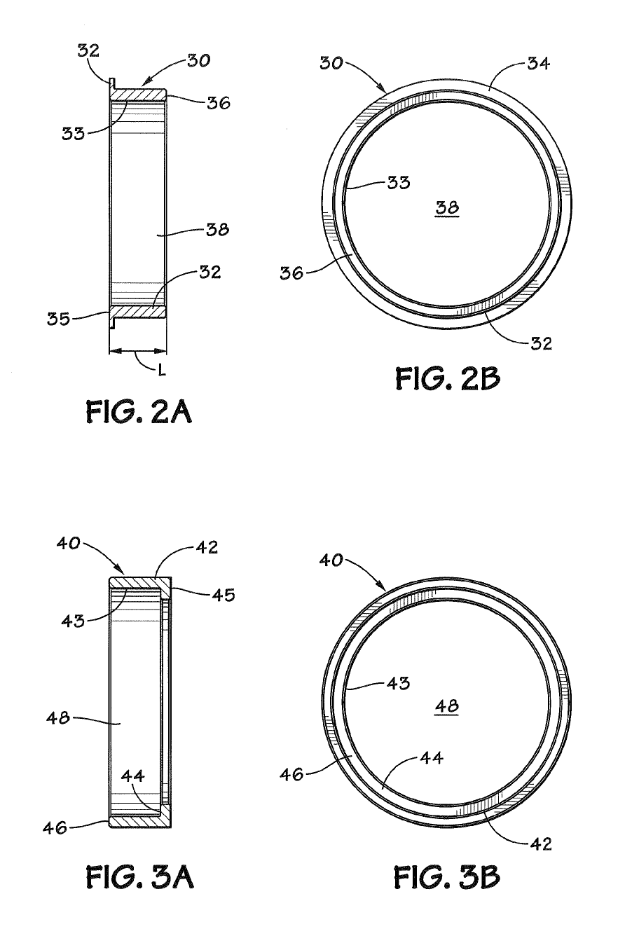

As shown in FIGS. 2A, 2B parts of one embodiment of the spacer 20 are shown in FIGS. 2A and 3A. A male part 30 has a body 32, an end lip 34, an edge 36, and a channel 38 through the body 32 from one end to the other. The channel 38 has an interior surface 33 which is relatively smooth and which is exposed to fluid flow when the spacer 20 is located within the coupling 12. The channel 48 has an interior surface 43. The body 42 has an end surface 45.

As shown in FIGS. 3A, 3B, a female part 40 has a body 42, an inner shoulder 44, an edge 46, and a channel 48 through the body 42 from one end to the inner shoulder 44. The lip 34 is part of an end surface 35.

The parts 30 and 40, in one aspect, are designed so that there is a friction fit between them, between the surface of the channel 38 and the surface 43 so that the parts are movable with respect to each other, but so that, after installation they will not fall apart. The amount of friction is sufficiently low that the parts move with respect to each other when they are contacted by tubulars being connected with the coupling.

The spacer parts are fashioned and dimensioned so that they will not protrude into the tubulars being connected with a coupling. The end surfaces 35 and 45 are fashioned and dimensioned so that they abut flush against and cover the ends of the tubulars 13, 14.

In one particular embodiment, the coupling 12 is on an API eight round coupling and the tubulars 13, 14 are API eight round oil country tubular goods (“OCTG”). In certain aspects the tubulars are either internally coated or have a liner installed (e.g. plastic, composite), or both. Thus the void space is filled and the ends of the tubulars are not exposed to damage from tools, wirelines and other items passing through the tubulars. Corrosion on a portion of the interior surface of the coupling is reduced, as is corrosion on the ends of the tubulars.

In certain embodiments of a spacer according to the present invention the lip 34 of the male member 30 is deleted. In certain embodiments of a spacer according to the present invention the shoulder 44 of the female member is deleted. In certain embodiments of a spacer according to the present invention both the lip 34 and the shoulder 44 are deleted.

Slightly less than the extent of the body 32 above the lip 34 (length L, FIG. 2A) is the distance that the members 30 and 40 can move with respect to each other to accommodate the final positions of tubular ends connected with a coupling as in FIG. 1. However, in one aspect as described below, some further movement toward each other of the tubular ends can be accommodated if the lip 34 is made so that it or part of it is separable from the body 32.

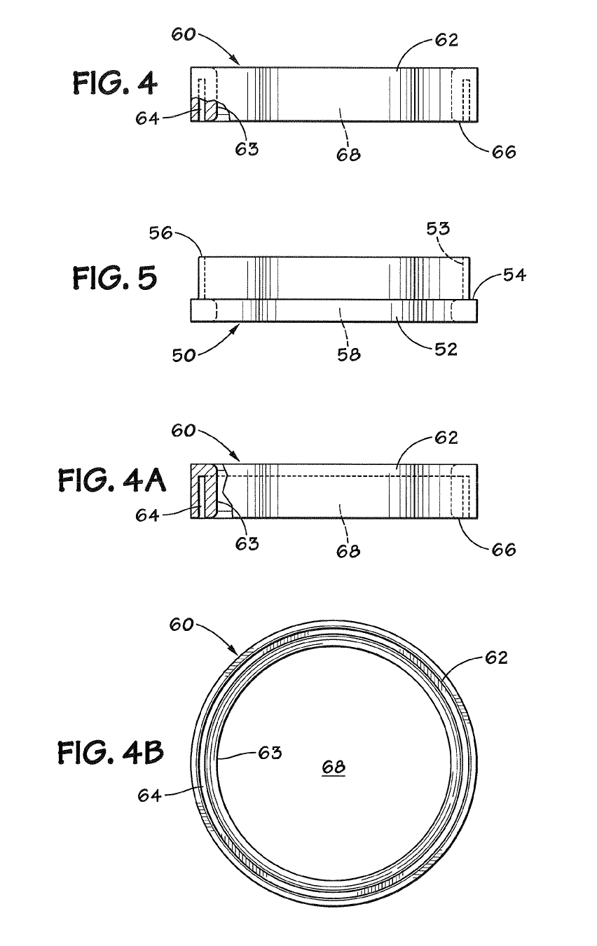

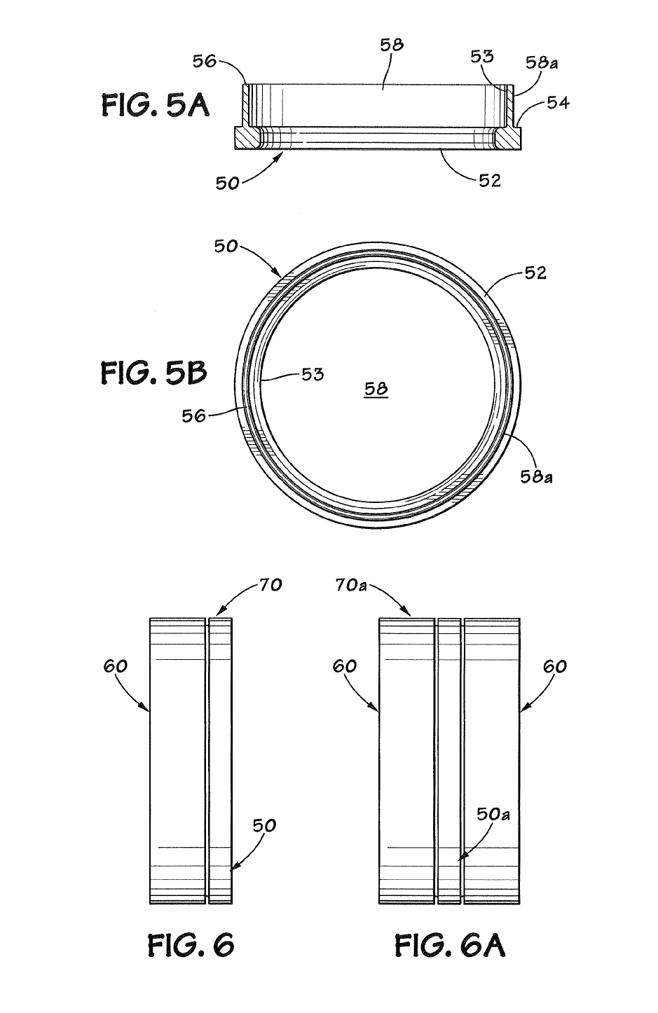

FIGS. 4-5B illustrate a male member 50 and a female member 60 of a spacer 70 according to the present invention (see FIG. 6). The male member 50 has a body 52, with a lip 54, an edge 56, and a channel 58 through the body 52 from one end to the other. The channel 58 has an interior surface 53 The female member 60 has a body 62, a circumferential recess 64 for receiving and holding part of the body 52 of the male member 50, an edge 66, and an interior channel 58 with an interior surface 53 from one end of the body 52 to the other. Spacers according to the present invention may have two, at least two, or more than two parts which fit together and compress when contacted by the ends of tubulars. FIG. 6A shows a spacer 70a according to the present invention, like the spacer 70, FIG. 6, with a male member 50a and two female members 60. The male member 50a has two channel portions like the channel portion 58a, FIG. 5A, each for insertion into a recess 64 of a corresponding female member 60.

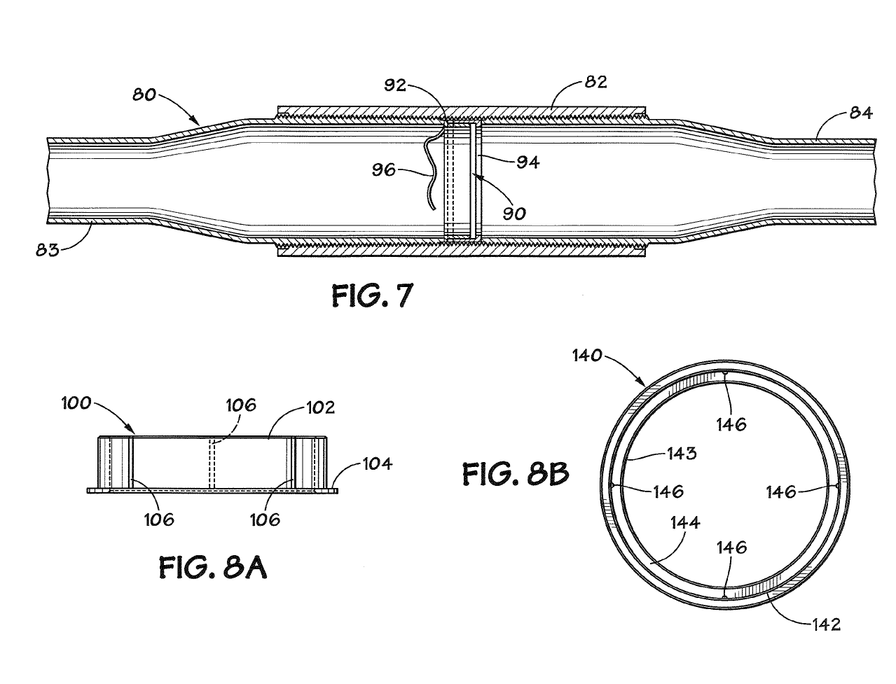

FIG. 7 illustrates a coupling system 80 which has a coupling 82; two connected tubulars 83, 84; and a spacer 90 according to the present invention with a male part 92 and a female part 94. The coupling and the tubulars can be like any coupling and tubulars described or referred to herein. The spacer 90 can be any length adjustable spacer according to the present invention which has a lip 96 on its male part. In the embodiment of FIG. 7, the lip 96 is fashioned and dimensioned so that as the coupling 82 is tightened with respect to the two tubulars 83, 84 and a portion of the female part 94 contacts the lip 96 of the male part, the force of the female part 94 against the lip 96 as the tubulars are tightened in place separates the lip 96 or part thereof (as in FIG. 7) from the body of the male part 92 providing for further compression of the male part 92 with respect to the female part 94 to accommodate the further movement toward each other within the coupling of the two end of the tubulars.

The lip 96 can be fashioned and dimensioned to be thus separable from the body of the male part by making its width sufficiently small that the force of the female part against separates it from the body of the male part; indentations and/or perforations can be provided around the lip 96 to facilitate its separation from the body; it can be thinner than the rest of the body; and/or a circumferential groove or recess may be formed in the lip adjacent the body to facilitate separation.

To increase friction between a male part and a female part of a spacer according to the present invention, one, two, three, four or more protrusions, ribs, or prongs, projections, can be added to the exterior surface of a male part or to the interior surface of a female part. These projection(s), etc. are sized, dimensioned, fashioned, and made of such material that they assist in holding the two parts together, but do not impede the movement of the two parts with respect to each other to accommodate ends of tubular members forcing the two parts together within a coupling. These projection(s), etc. may be formed integrally of the part or they may be connected or adhered to the part after it is made.

FIG. 8A shows a male part 100 according to the present invention whose aspect(s) and/or feature(s) may be used with any male part described or referred to herein. The male part 100 has a body 102 with a channel 103 through the body 102, a lip 104 and three projections 106 (one shown in dotted line) around the body 102 formed integrally of the body 102.

FIG. 8B shows a female part 140 with a body 142, a channel 143, an inner shoulder 144 and a plurality of inwardly projecting ribs 146 which will contact a male part when it is inserted into the female part 140. The ribs are shown as formed integrally of the body 142, but may be glued or welded to the body 142 (as may be the projections 106 to the body 102, and any rib, projection, prong or protrusion of any spacer according to the present invention).

Any spacer according to the present invention or part thereof may be made of any suitable metal, fiberglass, composite, wood, or plastic; including, but not limited to, zinc, aluminum, zinc alloys, aluminum alloys, tin, brass, bronze, stainless steel, steel, PTFE, PEEK, polyethylene, nylon, and/or KEVLAR (trademark) material.

The present invention, therefore, provides in at least certain, but not necessarily all, embodiments, a coupling systems for connecting two tubulars, the coupling system having: a coupling; a first tubular and a second tubular connected together by the coupling, each tubular having a tubular end within the coupling, the tubular ends spaced-apart from each other; and a spacer between the tubular ends and in contact therewith, the spacer comprising at least two parts, the at least two parts movable with respect to each other. Such a coupling system may have one or some, in any possible combination, of the following: the spacer having a first part and a second part, a portion of the first part receivable within and movable with respect to the second part; wherein the first part is a male part with a male body with a channel therethrough and with an outer lip, and the second part is a female part with a female body having a female edge and with a channel therethrough, the outer lip of the male part located for contact by the edge of the female part; wherein the male part has a male edge and the female part has an inner shoulder located for contact by the male edge of the male part; wherein each of the at least two parts has a body with a thickness sufficient to protect the tubular ends; wherein there is a space between the tubular ends and the spacer occupies said space; wherein the at least two parts comprise an inner part and an outer part, each of said inner and said outer part having a channel therethrough defined by an inner wall of a part body and said channels provide a smooth surface through the spacer for enhancing flow through the spacer and through the tubulars; wherein the at least two parts fit together with a friction fit; and/or wherein the at least two parts comprise a first part and a second part, at least one of said first part and said second part having at least one projection for contacting said other part to enhance a friction fit between said parts.

The present invention, therefore, provides in at least certain, but not necessarily all, embodiments, a coupling system for connecting two tubulars, the coupling system having: a coupling; a first tubular and a second tubular connected together by the coupling, each tubular having a tubular end within the coupling, the tubular ends spaced-apart from each other; a spacer between the tubular ends and in contact therewith, the spacer comprising at least two parts, the at least two parts movable with respect to each other; wherein each of the at least two parts has a body with a thickness sufficient to protect the tubular ends; wherein there is a space between the tubular ends and the spacer occupies said space; wherein the at least two parts comprise an inner part and an outer part, each of said inner and said outer part having a channel therethrough defined by an inner wall of a part body and said channels providing a smooth surface through the spacer for enhancing flow through the spacer and through the tubulars; and wherein the at least two parts fit together with a friction fit.

The present invention, therefore, provides in at least certain, but not necessarily all, embodiments, a spacer for use in a coupling for coupling together two tubulars, the coupling with a coupling body, the coupling body being generally cylindrical and having a channel therethrough, the coupling body with two spaced-apart ends, each end threaded for threaded mating with a tubular so that the coupling connects the two tubulars, the coupling having an interior wall, the spacer having: two parts, a first part and a second part, the first part movable with respect to the second part to accommodate a distance within a coupling between spaced-apart ends of two tubulars connected by the coupling. Such a coupling system may have one or some, in any possible combination, of the following: a portion of the first part receivable within and movable with respect to the second part; wherein each of the at least two parts has a body with a thickness sufficient to protect the tubular ends; wherein there is a space between the tubular ends and the spacer occupies said space; wherein the two parts comprise an inner part and an outer part, each said part having a channel therethrough defined by an inner wall of a part body and said channels providing a smooth surface through the spacer for enhancing flow through the spacer and through the tubulars; and/or wherein the two parts fit together with a friction fit.

The present invention, therefore, provides in at least certain, but not necessarily all, embodiments, a method for coupling together with a coupling two tubulars comprising a first tubular and a second tubular, the first tubular having an end with exterior threading, the second tubular having an end with exterior threading, the coupling having two threaded spaced-apart coupling ends, the method including: threadedly engaging each threaded end of each of two tubulars with a threaded end a coupling, the coupling comprising a coupling body with an interior wall and being generally cylindrical and having a channel therethrough, the coupling with two spaced-apart coupling ends, each coupling end threaded for threaded mating with a tubular so that the coupling is connectible to two tubulars, the coupling body having an interior wall; positioning a spacer within the coupling adjacent the interior wall of the coupling body, the spacer comprising two parts, a first part and a second part, the first part movable with respect to the second part to accommodate a distance within the coupling between spaced-apart ends of two tubulars; threadedly engaging the coupling with each of the tubulars; the spacer within the coupling and located between two spaced-apart ends of the tubulars; tightening the connection of the tubulars and the coupling; and contacting the spacer with an end of each tubular, the spacer adjusting to a final distance apart of the ends of the two tubulars within the coupling. Such a method may include a spacer wherein the at least two parts are an inner part and an outer part and said channels providing a smooth surface through the spacer for enhancing flow through the spacer and through the tubulars, each part having a channel therethrough defined by an inner wall of a part body.

Accordingly, while preferred embodiments of this invention have been shown and described, many variations, modifications and/or changes of the system, apparatus and methods of the present invention, such as in the components, details of construction and operation, arrangement of parts and/or methods of use, are possible, contemplated by the patentee, within the scope of the appended claims, and may be made and used by one of ordinary skill in the art without departing from the spirit or teachings of the invention and scope of appended claims. Thus, all matter herein set forth or shown in the accompanying drawings should be interpreted as illustrative and not limiting, and the scope of the invention and the appended claims is not limited to the embodiments described and shown herein.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The inventors may rely on the Doctrine of Equivalents to determine and assess the scope of their invention and of the claims that follow as they may pertain to apparatus not materially departing from, but outside of, the literal scope of the invention as set forth in the following claims.

All patents and applications identified herein are incorporated fully herein for all purposes. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. section. 112, paragraph 6 for any limitations of any of the claims herein, except for those in which the claim expressly uses the words ‘means for’ together with an associated function.

Whereas the present invention has been described in particular relation to the drawings attached hereto, it should be understood that other and further modifications apart from those shown or suggested herein, may be made within the scope and spirit of the present invention.

What is claimed is:

1. A coupling system for connecting two tubulars, the coupling system comprising a coupling, a first tubular and a second tubular connected together by the coupling, each tubular having a tubular end within the coupling, the tubular ends spaced-apart from each other, a spacer between the tubular ends and in contact therewith, the spacer comprising at least two parts, the at least two parts movable with respect to each other.

2. The coupling system of claim 1 further comprising the spacer comprising a first part and a second part, a portion of the first part receivable within and movable with respect to the second part.

3. The coupling system of claim 2 wherein the first part is a male part with a male body with a channel therethrough and with an outer lip, and the second part is a female part with a female body having a female edge and with a channel therethrough, the outer lip of the male part located for contact by the edge of the female part.

4. The coupling system of claim 3 wherein the male part has a male edge and the female part has an inner shoulder located for contact by the male edge of the male part.

5. The coupling system of claim 1 wherein each of the at least two parts has a body with a thickness sufficient to protect the tubular ends.

6. The coupling system of claim 1 wherein there is a space between the tubular ends and the spacer occupies said space.

7. The coupling system of claim 1 wherein the at least two parts comprise an inner part and an outer part, each of said inner and said outer part having a channel therethrough defined by an inner wall of a part body and said channels provide a smooth surface through the spacer for enhancing flow through the spacer and through the tubulars.

8. The coupling system of claim 1 wherein the at least two parts fit together with a friction fit.

9. The coupling system of claim 1 wherein the at least two parts comprise a first part and a second part, at least one of said first part and said second part having at least one projection for contacting said other part to enhance a friction fit between said parts.

10. A coupling system for connecting two tubulars, the coupling system comprising a coupling, a first tubular and a second tubular connected together by the coupling, each tubular having a tubular end within the coupling, the tubular ends spaced-apart from each other, a spacer between the tubular ends and in contact therewith, the spacer comprising at least two parts, the at least two parts movable with respect to each other, wherein each of the at least two parts has a body with a thickness sufficient to protect the tubular ends, wherein there is a space between the tubular ends and the spacer occupies said space, wherein the at least two parts comprise an inner part and an outer part, each of said inner and said outer part having a channel therethrough defined by an inner wall of a part body and said channels providing a smooth surface through the spacer for enhancing flow through the spacer and through the tubulars, and wherein the at least two parts fit together with a friction fit.

11. A spacer for use in a coupling for coupling together two tubulars, the coupling with a coupling body, the coupling body being generally cylindrical and having a channel therethrough, the coupling body with two spaced-apart ends, each end threaded for threaded mating with a tubular so that the coupling connects the two tubulars, the coupling having an interior wall, the spacer comprising two parts, a first part and a second part, the first part movable with respect to the second part to accommodate a distance within a coupling between spaced-apart ends of two tubulars connected by the coupling.

12. The spacer of claim 11 further comprising a portion of the first part receivable within and movable with respect to the second part.

13. The spacer of claim 11 wherein each of the at least two parts has a body with a thickness sufficient to protect the tubular ends.

14. The spacer of claim 11 wherein there is a space between the tubular ends and the spacer occupies said space.

15. The spacer of claim 11 wherein the two parts comprise an inner part and an outer part, each said part having a channel therethrough defined by an inner wall of a part body and said channels providing a smooth surface through the spacer for enhancing flow through the spacer and through the tubulars.

16. The spacer of claim 11 wherein the two parts fit together with a friction fit.
